(19) United States
(12) Patent Application Publication
(10) Pub. No.: US 2005/0207882 A1
(43) Pub. Date: Sep. 22, 2005

(54) Air circulating apparatus

(75) Inventor: Takashi Yoshida, Osaka (JP)

Correspondence Address: Russell D. Orkin;WEBB ZIESENHEIM LOGSDON ORKIN & HANSON, P.C., 700 Koppers Building, 436 Seventh Avenue, Pittsburgh, PA, 15219-1818, US

(73) Assignee: LUCKY SUN CORPORATION, Osaka (JP)

(21) Appl. No.: 11/076,481

(22) Filed: Mar. 4, 2005

(30) Foreign Application Priority Data
Mar. 5, 2004 (JP) PAT. 2004-62656

(51) Int. Cl. F03D 7/00; F01B 25/00; F04D 15/00; F01D 21/00; F01D 19/00; F01D 17/00; F03B 15/00; F04D 27/00; F25D 17/04; F25B 49/00

(52) U.S. Cl. 415/15

(57) ABSTRACT

An air circulating apparatus comprises: a portable and cylindrical main body having an upper and a lower openings, and having a predetermined height, the main body adapted to be capable of standing on its own; a blower mounted inside the main body for generating an upward air current; a discharging air guiding means provided adjacent said upper opening of the main body; a first temperature detecting means for sensing a temperature in an upper region inside a room; a second temperature detecting means for sensing a temperature in a lower region inside the room; and a controlling means for controlling the blower based on sensed results from said first temperature detecting means and said second temperature detecting means.

### BACKGROUND OF THE INVENTION

1. Field of the Invention

The present invention is directed to an air circulating apparatus for use with an air conditioner for improving air conditioning efficiency by reducing temperature difference in a room caused by the air conditioner.

2. Background of the Invention

Conventionally, when a room is heated, for example, in winter by an air conditioner, the heated air tends to stay in the vicinity of the ceiling while not sufficient heated air is supplied to the area near the floor, which lowers the heating efficiency and often results in wasted energy. In view of this, in order to improve the heating efficiency, Japanese Patent Application No. 2001-41519 has proposed an air conditioning assisting apparatus, provided separately from the air conditioner, that circulates air in a room.

With the conventional air circulating apparatus known from the above-mentioned Japanese Patent Application, an air duct for circulating indoor air is installed within a wall surface, so that air introduced by a blower through an opening near the floor surface is discharged into the room through an opening near the ceiling. Further, the air duct has an air exhaust for exhausting a part of the indoor air to the outdoor and an inlet formed near and in communication with the opening near the ceiling for introducing outdoor air. Therefore, in addition to the indoor air circulation, this conventional apparatus ventilate air by discharging indoor air and introducing outdoor air at the same time during the heating operation. The apparatus is thus installed as a part of the housing or building. This means that the apparatus cannot be used in an existing room without renovating or remodeling the room. Moreover, regarding the room temperature, this apparatus relies on an existing air conditioner for temperature control for the room. Hence, the apparatus cannot improve the heating efficiency unless heating in the room is provided by the air conditioner in a way that air circulation utilizing this technology cab provide uniform effects in the entire room. Another problem with this conventional technique is that the apparatus is continuously operated. Hence, although the apparatus allows ventilation, as this ventilation necessarily results in heat transfer, the air conditioner needs to work harder to compensate for the heat transfer (heat loss) in order to maintain the room temperature.

The present invention has been made to overcome the above-described shortcomings of the conventional apparatus. A primary object of the present invention is to provide an air circulating apparatus which has a simple construction, yet is capable of effective circulation and temperature control of indoor air, thereby to improve the heating efficiency.

### SUMMARY OF THE INVENTION

For accomplishing the above-noted object, an air circulating apparatus according to the present invention comprises: a portable and cylindrical main body having an upper and a lower openings, and having a predetermined height, the main body adapted to be capable of standing on its own; a blower mounted inside the main body for generating an upward air current; a discharging air guiding means provided adjacent said upper opening of the main body; a first temperature detecting means for sensing a temperature in an upper region inside a room; a second temperature detecting means for sensing a temperature in a lower region inside the room; and a controlling means for controlling the blower based on sensed results from said first temperature detecting means and said second temperature detecting means.

With this construction, a predetermined value (a predetermined temperature difference threshold between a high temperature and a low temperature) is set in advance in the controlling means. Then, when the difference between a temperature detected by the first temperature detecting means located in an upper region of a room and a temperature detected by the second temperature detecting means located in a lower region of the room becomes equal to or greater than the predetermined value, the controlling means activates the blower incorporated within the main body. When the temperature difference falls below the threshold, the controlling means deactivates the blower. The blower, when activated, takes in air from the lower opening and discharges air through the upper opening. The discharging air guiding means provided adjacent the upper opening guides this discharged air upward toward the area adjacent the ceiling of the room. In this way, the apparatus can allow the air current to move up, without needing any air duct. The blower is operated continuously until the difference between the high temperature and the low temperature inside the room is diminished to fall below the threshold. The blower can be switched off until it needs to be activated.

With the above, the indoor air will be drawn into the main body and then discharged upward by the blower, thereby to generate a vertical air convection inside the room, thus circulating the indoor air. As a result, the excessive temperature difference between the high temperature and the low temperature will be dissolved. In this way, the apparatus of the present invention, though compact, can effectively provide uniform indoor temperature distribution. Also, as the air discharging operation is stopped as soon as the temperature difference between the high and low temperatures has diminished to below the threshold, there is no need or possibility of excessive circulation of indoor air which would cause discomfort for a person in the room. Moreover, as the room temperature distribution becomes more uniform, the air conditioner will detect a temperature of an intermediate air layer. Hence, in the case of heating operation, the air conditioner will not heat the indoor air excessively, resulting in efficient energy consumption and in a comfortable temperature controlled by the air conditioner.

### BRIEF DESCRIPTION OF THE DRAWINGS

FIG. 1 is an overall appearance view of an air circulating apparatus according to one preferred embodiment of the present invention,

FIG. 2 is a vertical section view of a main body of the apparatus, and

FIG. 3 is an explanatory view of the embodiment.

### DETAILED DESCRIPTION OF THE PREFERRED EMBODIMENTS

Preferred embodiments of an air circulating apparatus in accordance with the present invention will be described in details with reference to the accompanying drawings.

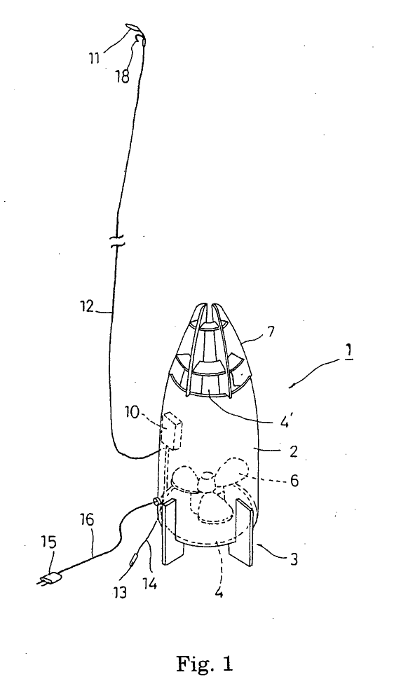

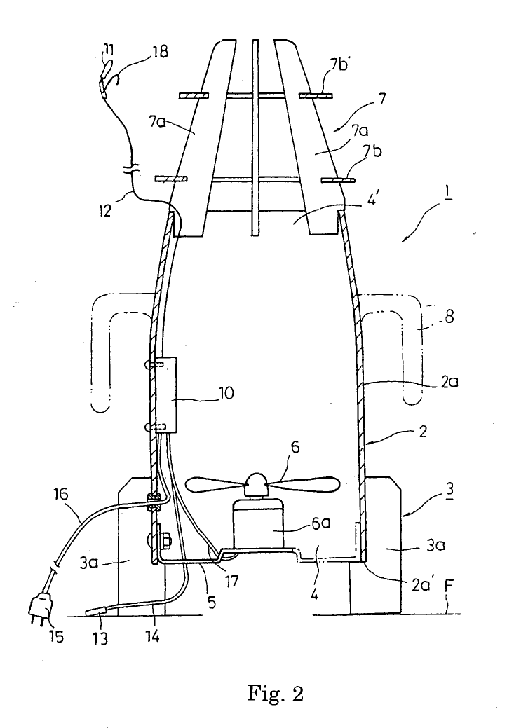

FIG. 1 shows an overall appearance of the air circulating apparatus according to one preferred embodiment of the present invention. FIG. 2 is a vertical sectional view of the main body of the apparatus.

The air circulating apparatus 1 according to this embodiment is constructed as a portable type apparatus. The apparatus 1 includes a cylindrical main body 2 having readily transportable dimensions, a blower 6 mounted inside the main body 2, an upper temperature detecting sensor 11 (first temperature detecting means) that can be placed at an upper location inside the room where the apparatus is used to detect a temperature in the upper region of the room, a lower temperature detecting sensor 13 (second temperature detecting means) that can be located near or on the floor (referred to as an installing surface) inside the room and configured to detect a temperature in the lower region of the room, and a controller 10 (controlling means) for controlling the blower 6, based on detection results from at least one of or both of the upper and lower temperature sensors 11, 13.

The main body 2 includes a cylindrical body portion 2a and a support leg portion 3 attached to the lower part of the body portion 2a and comprising a plurality of leg members 3a such that a predetermined space is formed between the lower end 2a′ of the body portion 2a and the installing surface F. The body section 2a and the leg members 3a may be made of resin, metal, composite materials, or other known materials. In this embodiment, four vertically extending rectangular leg members 3a that are symmetrically located are used to support the main body 2. However, any other number of the leg members 3a may be used. The leg members 3a does not have to be located symmetrically around the main body 2. Further, the body portion 2a defines upper and lower openings 4, 4′. As shown in FIG. 1, the apparatus as a whole presents a rocket-like configuration with a tapered top portion. However, other different configurations, such as cylindrical, conical, or a shape with a widening top as well as other shapes may be readily used. Also, the expressions such as cylindrical and conical are not meant to be restricted to shapes with circular cross section. Rather, they may refer to shapes with polygonal cross sections including rectangular, or triangular cross sections or even irregular shaped cross sections. The body portion 2a has its longitudinal dimension (vertical height) greater than its lateral dimension (i.e. its width).

A metallic support member 5 is attached to the lower inside face of the body portion 2a of the main body 2 by nuts and bolts as shown in FIG. 2. The support member 5 supports thereon the blower 6 with a rotational axis of the blower 6 being substantially aligned with a longitudinal axis of the body portion 2a. However, the blower 6 does not have to be aligned with the longitudinal axis especially when there is no inherent unique longitudinal axis for a particular shape of the body portion used. The blower 6 includes propeller-like blades oriented upward and the blower 6 is directly coupled to and driven by an electric motor 6a. Further adjacent the upper opening 4′ of the body portion 2a of the main body 2, a plurality of vertically elongate guide plates 7a are attached such that their surfaces are oriented toward the center of the circular cross section of the body section 2a and are distributed around the periphery of the opening 4′ at equal angular positions. The guide plates 7a may be accommodated partially or entirely within the body portion 2a. These guide plates 7a are assembled and connected to each other via two connecting rings 7b, 7b′ provided at vertically intermediate positions of the guide plates 7a. In this particular embodiment, the rings 7b, and 7b′ are oriented horizontally and parallel to each other. However, they do not have to be horizontal or parallel to each other. For example, one ring may cross the other ring. It is also within the present invention to provide no connection rings or to provide more than two rings to support the guide plates 7a. Also, the connecting rings do not have to be ring-shaped. They may project outwardly from the outer edges of the guide plates 7a as shown in FIG. 2 or they may be dimensioned such that their outer edges stay within the outer edges of the guide plates 7a as shown in FIG. 1. These components together form a discharging air guiding assembly 7 (discharging air guiding means) which is engaged and connected at its lower end with the body portion 2a for guiding the air current to be discharged straight upward from the body portion 2a. The guide plates 7a may be simply snug-fit to the periphery of the upper opening 4′ or may be detachably attached to it or fixedly attached to the body portion 2a by any known means such as glue, a bolt and nut arrangement.

The controller 10 (controlling means), though not shown, has a plurality of electrical elements such as a transformer, controlling elements, etc. which are mounted on a substrate. This assembly is housed within a box-like casing with its outer side being sealed with an insulating material. This controller 10 provides a controlling function of driving the blower 6 by powering its motor 6a when the difference between the temperature detected by the upper temperature sensor 11 and the temperature detected by the lower temperature sensor 12 becomes equal to or greater than the predetermined temperature difference (threshold) of 2° C. The controller 10 is attached to an appropriate position on the inner surface of the body portion 2a of the main body 2. The controller 10 is connected with a power line 16 (power input line) having a power connector 15 to be connected to a power outlet (socket) and connected also via leads 12, 14 to the first and second temperature sensors 11 and 13 attached to the respective leading ends of the leads 12, 14, so that the controller 10 receives inputs from these temperature sensors 11, 13. The controller 10 is connected also with a further power line 17 (power output line) for transmitting its drive controlling output to the blower drive motor 6a. The electric wire 12 extends generally upwards from the controller 10 and exits from the body portion 2a from the upper opening 4′ and extends toward the first temperature sensor 11. The electric wire 14 generally extends downwardly from the controller 10 and exits from the body portion 2a through a hole in the support member 5 and extends toward the second temperature sensor 13. The power line 16 extends out from the body section 2a through a hole formed on a side of the body section 2a as shown in FIG. 2.

In order to allow the upper temperature sensor 11 to be supported to a mounting element (not shown) fixed at an upper location inside the room, a support element such as a hook 18 or the like is attached to the free end of the lead 12. This mounting element and the support element can be any known arrangement, such as ones involving adhesives, nails, nuts and bolts, a hook and a loop, that allows a sensor to be mounted to a part of the room. In case the apparatus is used at a same location for a long period of time, it is preferred that the upper temperature sensor 11 be fixedly attached. Also, regarding the lower temperature sensor 13, it is preferred that this sensor 13 be located at an appropriate temperature detecting position by appropriately selecting the length of the lead 14 so that this sensor 13 may be fixed without the risk of being damaged during e.g. cleaning of the room.

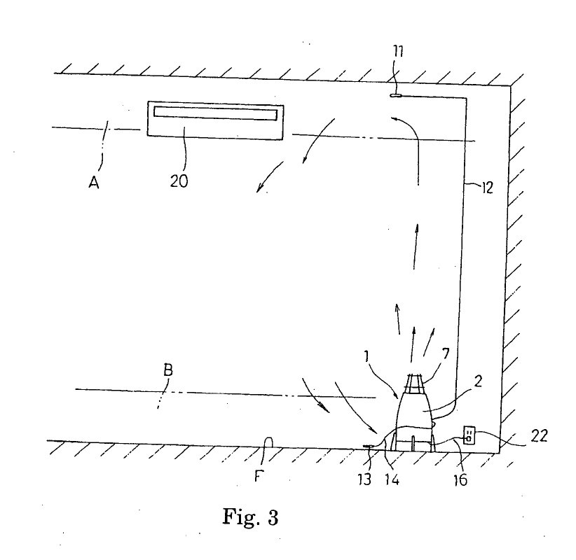

Operation of the air circulating apparatus 1 of this embodiment as described above will be described next with reference to FIG. 3. The main body 2 is placed at an appropriate location on a floor surface in a room in which an air conditioner 20 is installed. The upper temperature sensor 11 is placed at a position near the ceiling, whereas the lower temperature sensor 13 is placed at an appropriate position on the floor surface preferably where the sensor 13 will not interfere with people's movements. The power line 16 is connected to the electric outlet 22 available in the room. With the power-on, the upper temperature sensor 11 will detect the temperature in a warm air layer A adjacent the ceiling of the room, whereas the lower temperature sensor 13 will detect the temperature in a cooler air layer B adjacent the floor surface F. The sensors 11, 13 respectively transmit the detected temperatures signals to the controller 10. When the temperature difference between the detected temperatures of the two sensors 11, 13 is equal to or greater than the predetermined temperature difference (threshold) of 2° C., the controller 10 activates the motor 6a of the blower 6.

When the blower 6 is turned on, the air from the lower temperature air layer B in the lower area is drawn in through the lower opening 4 of the main body 2 and is then discharged through the upper opening 4′ of the main body 2. The air discharged from the upper opening 4′ will be guided straight upward by the discharging air guiding assembly 7. This upward air current then will reach the vicinity of the ceiling and then change its direction to be distributed throughout the room. The air at the warm air layer A which remains at the upper area inside the room is caused to flow by the upward air flow. Also, the air at the lower temperature air layer B which remains adjacent the floor surface F is moved and drawn into the main body 2 by the drive of the blower 6. As a result, an air convection is initiated in the room where the warm air which stayed in the upper area moves the lower temperature air in the lower area upwardly. This causes a movement of indoor air toward a uniform temperature distribution of the indoor air irrespectively of the air discharge from the air conditioner 20.

When the temperature difference is eventually dissolved by the above-described indoor air movement, the room temperature is appropriately regulated by the air conditioner 20. When the temperature difference between the temperature detected by the upper temperature sensor 11 and one detected by the lower temperature sensor 13 becomes less than the threshold of 2° C., the controller 10 will deactivate the blower 6 by stopping the power supply to its drive motor 6a. Therefore, the air circulating apparatus 1 will be stopped, whereas the air conditioner 20 continues its air conditioning operation. In this way, the temperature inside the room is kept at the set temperature of the air conditioner 20 without unnecessary excessive operation of the air conditioner, resulting in saved energy.

Since the air circulating apparatus 1 according to the present embodiment is a portable type, a pair of carrying handles 8 may be attached to outer lateral faces of the body portion 2a of the main body 2 as shown by dotted lines in FIG. 2. These handles 8 will help user carry the apparatus when desired. For instance, when the apparatus is needed in a room which is not normally used, for e.g. a business meeting, the user can carry the air circulating apparatus 1 into this room to used it with an air conditioner installed in this room. The active air circulation by the apparatus will help improve the efficiency of air conditioning operation by the air conditioner. In particular, it is difficult to heat air near the floor or people's feet by an air conditioner in winter. The air circulating apparatus 1 of the present invention helps the air conditioner quickly and effectively heat the air near the feet by the forced circulation of the warmed air. Moreover, as this apparatus is compact and as the apparatus is stopped automatically once the predetermined temperature difference condition (threshold of 2° C. or more) is met and is also automatically activated again once the detected condition deviates from the predetermined threshold, uniform indoor temperature distribution can be achieved automatically. Therefore, this apparatus can contribute not only to improvement of operation efficiency of the air conditioner to be used therewith, but also to improvement of the living condition.

Without changing its basic construction, the air circulating apparatus 1 of the present invention may be modified in the shape of its main body 2 and/or its air circulating capacity, depending on a condition or environment where the apparatus is to be used. With such appropriate modifications, the apparatus may be usable not only in a room equipped with an air conditioner, but also for e.g. promoting air circulation in an agricultural green house. In this case, with the effective restriction of a temperature difference between the upper temperature and the lower temperature made possible by the invention's apparatus, it is possible to more efficiently use fuel for maintaining temperature required for growing plants inside the green house, which results in energy and fuel savings. For effective use in an elongate and large indoor space such as in a green house, a number of air circulating apparatuses of the present invention, appropriately spaced apart from each other, may be used. Needless to say, such arrangement will not cause any problem in the function of the apparatus since each apparatus automatically stops its operation once the temperature difference falls within the predetermined temperature.

In the foregoing embodiment, the controller uses the threshold or the predetermined temperature difference of 2° C. between the upper temperature and the lower temperature. The invention is not limited this particular value of the predetermined temperature. It is needless to say that various other integer or non-integer values are possible, depending on a particular need. Moreover, regarding the guide members connected to the upper opening 4′ of the main body 2, though not shown, an assembly of ducts or guide plates, that are inclined or whose angle may be adjusted for changing the discharging direction, may be assembled and connected to the upper opening 4′ depending on a particular place where the apparatus is desired to be used. Further, the outer shape of the main body 2 may readily be varied. Further and other modifications in the shape and constructions of the respective components will be obvious for one skilled in the art. It is understood that the present invention includes all such modifications.

1. An air circulating apparatus comprising:
a portable and cylindrical main body having an upper and a lower openings, and having a predetermined height, the main body adapted to be capable of standing on its own;
a blower mounted inside the main body for generating an upward air current;
a discharging air guiding means provided adjacent said upper opening of the main body;
a first temperature detecting means for sensing a temperature in an upper region inside a room;
a second temperature detecting means for sensing a temperature in a lower region inside the room; and
a controlling means for controlling the blower based on sensed results from said first temperature detecting means and said second temperature detecting means.

2. The air circulating apparatus according to claim 1, wherein said main body has a carrying handle for carrying the apparatus.

3. The air circulating apparatus according to claim 1, wherein at least one of said first and second temperature detecting means has a member that allows the at least one of said first and second temperature detecting means to be attached to a desired location.

4. The air circulating apparatus according to claim 1, wherein said first and second temperature detecting means are capable of being detachably attached to the main body.

5. The air circulating apparatus according to claim 1, wherein the main body has a body portion supported by a plurality of leg members.

6. The air circulating apparatus according to claim 1, wherein the discharging air guiding means has at least one plate-shaped member for guiding air.

7. The air circulating apparatus according to claim 6, wherein the discharging air guiding means has a plurality of elongate plate-shaped members that can be oriented vertically and a support member interconnecting at least some of the plurality of elongate plate-shaped members.

8. The air circulating apparatus according to claim 5, wherein the body portion has its longitudinal dimension greater than its lateral dimension.

9. An air circulating apparatus comprising:
a portable main body adapted to be positioned on a floor and having an upper and a lower openings;
a plurality of legs supporting the main body;
an electric blower mounted inside the main body for generating an upward air current;
a guide plate provided adjacent the upper opening of the main body;
a first temperature sensor for sensing a temperature in an upper region inside a room;
a second temperature sensor for sensing a temperature in a lower region inside the room; and
a controlling means for controlling an operation of the blower based on sensed signals from both said first temperature sensor and said second temperature sensor.
